(19) United States
(12) Patent Application Publication
(10) Pub. No.: US 2026/0118513 A1
(43) Pub. Date: Apr. 30, 2026

(54) THREE-DIMENSIONAL SCANNING DEVICE, AND SCANNING-BASED MODELING METHOD IMPLEMENTED BY THE SAME

(71) Applicant: National Kaohsiung University of Science and Technology, Kaohsiung (TW)

(72) Inventor: Jui-Hung CHENG, Kaohsiung City (TW)

(21) Appl. No.: 19/083,741

(22) Filed: Mar. 19, 2025

(30) Foreign Application Priority Data
Oct. 29, 2024 (TW) 113141333

(51) Int. Cl. G01S 17/894; G01S 7/481; G01S 17/08; G06T 17/00

(52) U.S. Cl. CPC G01S 17/894; G01S 7/4817; G01S 17/08; G06T 17/00

(57) ABSTRACT

A 3D scanning device includes a distance measuring module, a scanning platform, a control module and a power source module that are accommodated in a space defined by a shell that is operable to open and close. The distance measuring module includes a bracket detachably mounted on the shell, and multiple optical rangefinders on the bracket. The scanning platform includes a stepper motor in the space, and a support base rotatable by the stepper motor. The control module is communicatively connected to the optical rangefinders and the stepper motor. The power source module provides electric power to the optical rangefinders, the stepper motor and the control module.

### CROSS-REFERENCE TO RELATED APPLICATION

This application claims priority to Taiwanese Invention patent application No. 113141333, filed on Oct. 29, 2024, the entire disclosure of which is incorporated by reference herein.

### FIELD

The disclosure relates to a three-dimensional (3D) scanning device and a scanning-based modeling method, and more particularly to a 3D scanning device and a scanning-based modeling method that are adapted for reverse engineering.

### BACKGROUND

3D reverse scanning devices are generally categorized into two main types: contact-based measurement and non-contact measurement. Scanning modules of contact-based measurement primarily use mechanical probes or other physical contact methods to measure a surface of an object through direct contact. This method is commonly used in industries such as manufacturing, engineering, and scientific research for dimensional measurements. The contact-based measurement is suitable for measuring small to medium-sized mechanical and hardware components, including surface dimensions (to verify compliance with tolerances), simple 2D and 2.5D shapes, and basic external contours. For measuring large components or products with complex 3D surfaces, non-contact 3D scanning devices are typically used. These devices rely on machine vision components such as LiDAR or radar instead of physical contact. Using techniques like structured light scanning, laser scanning, and infrared scanning through optical lenses, data of reflected light are captured to reconstruct a 3D computer aided design (CAD) model of the object. Non-contact measurement is particularly suited for reverse engineering in automotive and machinery industries, allowing precise measurement of complex geometries and dimensions of existing components. The resultant 3D models can be used for replicating external shapes and dimensions or for design modifications and improvements.

Common non-contact 3D scanning devices come in various types, including handheld, benchtop, and machine-mounted models. Small handheld scanners are lightweight, portable, and relatively affordable, but have limitations in measurement range, dimensional accuracy, and suitability for scanning large objects. In contrast, benchtop and machine-mounted scanners offer high precision and capability to rapidly scan large objects, but are stationary and cannot be easily transported for on-site use. Additionally, these systems are more expensive, require trained professionals to operate, and thus are suited for use in dedicated, controlled environments rather than field applications.

### SUMMARY

Therefore, an object of the disclosure is to provide a 3D scanning device that can alleviate at least one of the drawbacks of the prior art.

According to the disclosure, the 3D scanning device, includes a shell, a distance measuring module, a scanning platform, a control module, and a power source module. The shell surrounds and defines an accommodating space, and is operable to open or close for a purpose of allowing access to or sealing the accommodating space. The distance measuring module includes a bracket that is detachably mounted on the shell, and a plurality of optical rangefinders that are mounted to the bracket. Each of the plurality of optical rangefinders is configured to project light including at least one of laser, infrared or structured light, and to capture reflection of the light thus projected. The scanning platform includes a stepper motor that is disposed in the accommodating space, and a support base that is configured to be rotated by the stepper motor with a rotation axis perpendicular to a top surface of the support base. The control module is disposed in the accommodating space and is communicatively connected to the plurality of optical rangefinders and the stepper motor. The power source module is disposed in the accommodating space, and is configured to provide electric power to the plurality of optical rangefinders, the stepper motor, and the control module.

Another object of the disclosure is to provide a scanning-based modeling method that is implemented by the 3D scanning device of the disclosure.

According to the disclosure, the scanning-based modeling method includes a scanning step and a converting step. In the scanning step, the plurality of optical rangefinders perform scanning on an object to collect multiple point datasets of the object respectively at multiple angles relative to the object, and the distance measuring module transmits the multiple point datasets to a processing system. In the converting step, the processing system converts the multiple point datasets into three-dimensional coordinates, and constructs a complete model of the object based on the three-dimensional coordinates.

Yet another object of the disclosure is to provide a scanning-based modeling method that is implemented by multiple 3D scanning devices of the disclosure.

According to the disclosure, the scanning-based modeling method includes a preparing step, a scanning step, and a converting step. In the preparing step, the plurality of three-dimensional scanning devices are arranged around an object at different angles relative to the object, and the plurality of three-dimensional scanning devices are spaced apart from each other. In the scanning step, the plurality of optical rangefinders of the plurality of three-dimensional scanning devices perform scanning on the object to collect multiple point datasets of the object respectively from the plurality of three-dimensional scanning devices, and the distance measuring modules of the plurality of three-dimensional scanning devices transmit the multiple point datasets to a processing system. In the converting step, the processing system converts each of the multiple point datasets into three-dimensional coordinates, constructs a local model of the object based on the three-dimensional coordinates for each of the multiple point datasets, and combines the local models respectively constructed for the multiple point datasets to form a complete model of the object.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of a 3D scanning device according to the disclosure.

FIG. 2 is a top view illustrating an expanded state of the embodiment of the 3D scanning device.

FIG. 3 is a side view illustrating the expanded state of the embodiment of the 3D scanning device.

FIG. 4 is a side view illustrating a stowed state of the embodiment of the 3D scanning device.

FIG. 5 is a top view illustrating the stowed state of the embodiment of the 3D scanning device.

FIG. 6 is a flow chart illustrating an embodiment of a scanning-based modeling method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

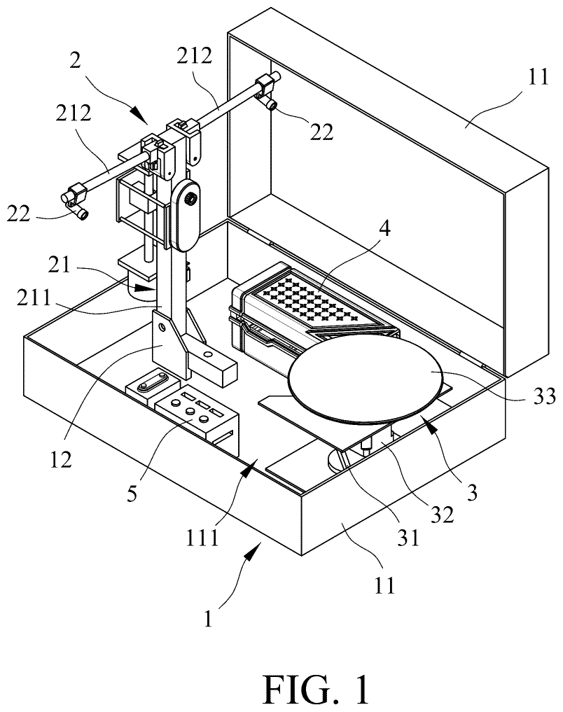

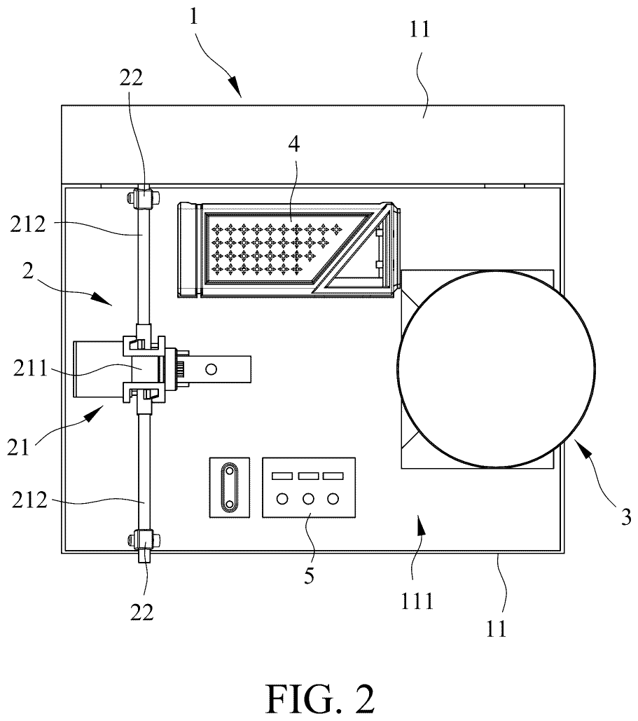

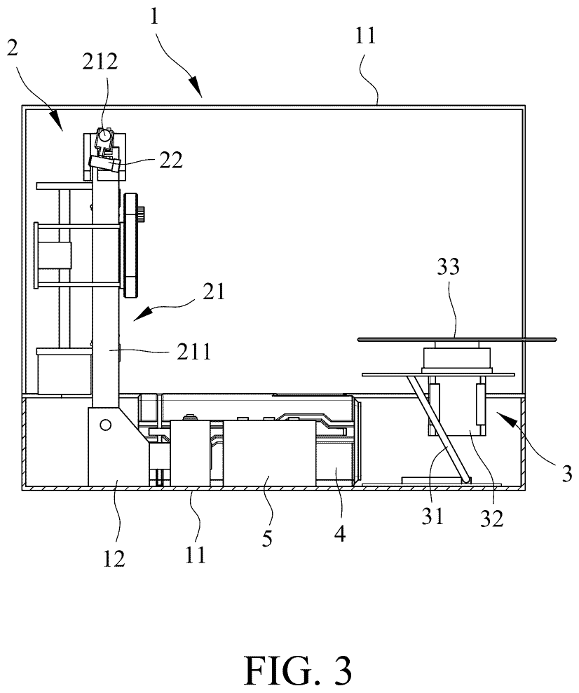

Referring to FIGS. 1 to 3, an embodiment of a 3D scanning device according to this disclosure is shown to be in an expanded state, and includes a shell 1, a distance measuring module 2, a scanning platform 3, a control module 4 and a power source module 5, where the distance measuring module 2, the scanning platform 3, the control module 4 and the power source module 5 are mounted on the shell 1. The shell 1 includes two box-shaped compartments 11 that are pivotally connected to each other via, for example, one or more hinges, and a folding joint 12 that is detachably mounted on one of the compartments 11. The compartments 11 are operable to open or close. When being closed, the compartments 11 cooperatively surround and define an accommodating space 111 that is sealed by the shell 1. When the compartments 11 are opened, access to the accommodating space 111 is allowed. In the illustrative embodiment, the distance measuring module 2, the scanning platform 3, the control module 4 and the power source module 5 are mounted on the same compartment 11, but this disclosure is not limited in this respect.

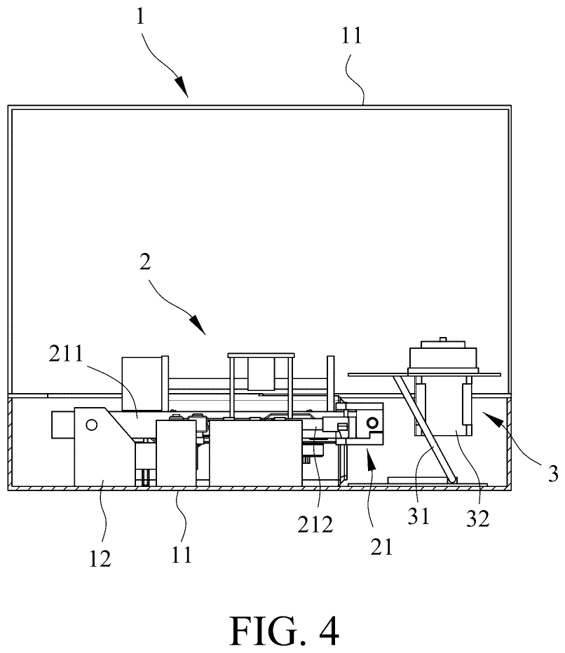

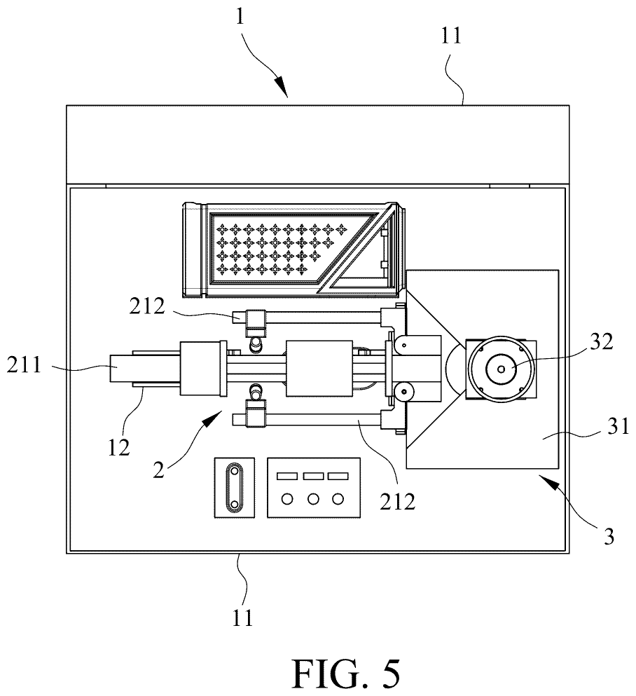

The distance measuring module 2 includes a bracket 21 that is detachably mounted on the folding joint 12, and multiple (two in the illustrative embodiment) optical rangefinders 22 that are mounted on the bracket 21. The folding joint 12 allows the bracket 21 to be folded or unfolded. The bracket 21 includes a post 211 mounted on the folding joint 12, and two extending arms 212 connected to the post 211 through a folding mechanism, such as a joint mechanism. When the shell 1 is opened and the bracket 21 is in an unfolded position as shown in FIGS. 1 through 3, the post 211 extends upward and is perpendicular to a horizontal plane, and the extending arms 212 extend laterally and oppositely from the post 211 (i.e., extend in opposite horizontal directions that are parallel to the horizontal plane). The bracket 21 is foldable from the unfolded position to a folded position through the connection with the folding joint 12, as shown in FIGS. 4 and 5. When the bracket 21 is in the folded position, the extending arms 212 are folded relative to the post 211 and rest parallel to the post 211. Each of the optical rangefinders 22 is mounted on a respective one of the extending arms 212, and is configured to project light that is one of laser, infrared or structured light, and to capture reflection of the light thus projected. In some embodiments, there may be more than two optical rangefinders 22 mounted on the extending arms 212 and/or even the post 211, and this disclosure is not limited in this respect.

Referring to FIGS. 1 to 3, the scanning platform 3 includes an adjusting frame 31 that is detachably mounted on the corresponding compartment 11 and that is disposed in the accommodating space 111, a stepper motor 32 that is mounted on the adjusting frame 31 and that is disposed in the accommodating space 111, and a support base 33 that is detachably mounted on and rotatable by the stepper motor 32, with a rotation axis perpendicular to a top surface of the support base 33. The adjusting frame 31 is operable to raise or lower the stepper motor 32 and the support base 33, thereby adjusting a height of the top surface of the support base 33. The control module 4 may include, for example, a microcontroller, and is disposed in the accommodating space 111 and communicatively connected to the optical rangefinders 22 and the stepper motor 32. The power source module 5 may include, for example, a battery module and/or a converter module, and is disposed in the accommodating space 111 and connected to the optical rangefinders 22, the stepper motor 32 and the control module 4 for providing electric power thereto.

When the 3D scanning device is to be shifted from an expanded state (see FIGS. 1 through 3) to a stowed state (see FIGS. 4 and 5), the first action is to fold the extending arms 212 to make them parallel to the post 211, and then the post 211 is folded to make the bracket 21 switch from the unfolded position (where the post 211 is perpendicular to the horizontal plane) to the folded position (where the post 211 is parallel to the horizontal plane). Subsequently, the support base 33 is detached from the stepper motor 32, and the adjusting frame 31 is lowered, thereby ensuring that the scanning platform 3 can be stowed in the accommodating space 111. Then, the compartments 11 are closed to seal the accommodating space 111, so that the distance measuring module 2, the scanning platform 3 (including the detached support base 33), the control module 4, and the power source module 5 are received in the accommodating space 111. In some embodiments, the shell 1 may be designed to have a handle or other features for easy carrying, allowing users to conveniently transport the 3D scanning device. In some embodiments, a mounting plate (not shown) with multiple mortises may be provided on one of the compartments 11, and the folding joint 12, the scanning platform 3, the control module 4, and the power source module 5 are inserted into these mortises using tenon-and-mortise connections.

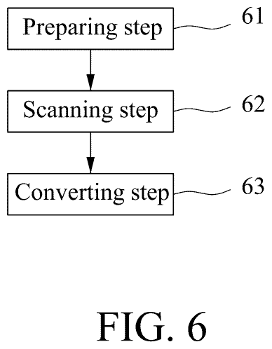

Referring to FIGS. 1, 3 and 6, the 3D scanning device of this disclosure may be used in various ways to implement scanning-based modeling, which includes a preparing step 61, a scanning step 62 and a converting step 63. In the preparing step 61 of the first implementation, a small-sized object (not shown) that serves as a modeling target is placed on the top surface of the support base 33, and the adjusting frame 31 is operated to raise or lower the support base 33 to make the top surface of the support base 33 positioned at a desired height. In the scanning step 62 of the first implementation, the stepper motor 32 drives the support base 33 to rotate for one or more full revolutions, during which the optical rangefinders 22 scan the object to continuously collect multiple point datasets of the object respectively at multiple angles relative to the object; and the distance measuring module 2 transmits the point datasets to a processing system (e.g., a computer system, not shown). In the converting step 63 of the first implementation, the processing system may select and convert some of the point datasets that respectively correspond to some specific angles or all of the point datasets into 3D coordinates, and construct a complete model of the object based on the 3D coordinates.

The second implementation of the scanning-based modeling is suitable for a larger object (e.g., too large to be placed on the support base 33) that serves as the modeling target, and has different preparing step 61 and scanning step 62 from the first implementation. In the preparing step 61 of the second implementation, the post 211 is detached from the folding joint 12, so as to separate the distance measuring module 2 from the compartments 11 for a person to use his/her hand or a movable machine (e.g., a robot, a vehicle, etc.) to hold the bracket 21. In the scanning step 62 of the second implementation, the person or the machine that holds the bracket 21 moves the bracket 21 along with the optical rangefinders 22 around the object for one or more full revolutions, during which the optical rangefinders 22 scan the object, thereby collecting multiple point datasets of the object respectively at multiple angles relative to the object. The second implementation has the same converting step 63 as the first implementation to construct a complete model of the object, so details thereof are not repeated for the sake of brevity.

The third implementation of the scanning-based modeling is implemented using a plurality of the 3D scanning devices according to this disclosure, and is suitable for an even larger object that serves as the modeling target. In the preparing step 61 of the third implementation, the 3D scanning devices are arranged around an object at different angles relative to the object. In some embodiments, the 3D scanning devices are arranged at equal angular intervals in an annular pattern around the object. In the scanning step 62 of the third implementation, the optical rangefinders 22 of each of the 3D scanning devices scan the object at a corresponding angle relative to the object, so that the 3D scanning devices collect multiple point datasets of the object respectively at multiple angles relative to the object. Then, the distance measuring modules 2 of the 3D scanning devices transmit the point datasets to the processing system. In the converting step 63 of the third implementation, the processing system may select and convert some of the point datasets that respectively correspond to some specific angles or all of the point datasets into 3D coordinates, and construct a local model of the object based on the 3D coordinates for each of the selected point datasets. Then, the processing system combines the local models that are respectively constructed for the selected point datasets into a complete model of the object.

To sum up, in the embodiment of this disclosure, the distance measuring module 2, the scanning platform 3, the control module 4 and the power source module 5 can be stored in the accommodating space 111. When the shell 1 is closed to seal the accommodating space 111, the 3D scanning device is stowed as a suitcase, thereby achieving high portability and flexibility. When the object that serves as the modeling target is not large, the object can be placed on the scanning platform 3 for scanning and modeling. When the object is large, the bracket 21 that is equipped with the optical rangefinders 22 can be detached from the shell 1, and the scanning can be performed by a person or a movable machine holding the bracket 21 and moving around the object. In an alternative approach, multiple 3D scanning devices can be arranged around the object at different angles relative to the object to scan local appearances of the object, respectively, and then the local appearances are integrated into a complete 3D model of the object through merging and stitching. Accordingly, the embodiment of this disclosure is adapted to modeling targets of various sizes, and thus offers greater versatility.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A three-dimensional scanning device, comprising:
a shell surrounding and defining an accommodating space, and operable to open or close for a purpose of allowing access to or sealing the accommodating space;
a distance measuring module including a bracket that is detachably mounted on said shell, and a plurality of optical rangefinders that are mounted to said bracket, wherein each of said plurality of optical rangefinders is configured to project light including at least one of laser, infrared or structured light, and to capture reflection of the light thus projected;
a scanning platform including a stepper motor that is disposed in the accommodating space, and a support base that is configured to be rotated by said stepper motor with a rotation axis perpendicular to a top surface of said support base;
a control module disposed in the accommodating space and communicatively connected to said plurality of optical rangefinders and said stepper motor; and
a power source module disposed in the accommodating space and configured to provide electric power to said plurality of optical rangefinders, said stepper motor, and said control module.

2. The three-dimensional scanning device as claimed in claim 1, wherein said shell includes two compartments that are pivotally connected to each other, that are operable to open or close, and that cooperatively define the accommodating space when being closed.

3. The three-dimensional scanning device as claimed in claim 2, wherein said bracket of said distance measuring module includes a post that extends upward when said shell is opened and said bracket is in an unfolded position, and two extending arms that extend laterally and oppositely from said post when said shell is opened and said bracket is in the unfolded position, and
wherein said plurality of optical rangefinders are disposed on said two extending arms.

4. The three-dimensional scanning device as claimed in claim 3, wherein said shell further includes a folding joint mounted on one of said two compartments, connected to said post, and configured to allow said bracket to be folded from the unfolded position to a folded position, and
wherein said post is perpendicular to a horizontal plane when said bracket is in the unfolded position, and is parallel to the horizontal plane when said bracket is in the folded position.

5. The three-dimensional scanning device as claimed in claim 4, wherein each of said two extending arms is foldable relative to said post, thereby resting parallel to said post.

6. The three-dimensional scanning device as claimed in claim 5, wherein said scanning platform further includes an adjusting frame that is detachably mounted on said one of said two compartments, and
wherein said stepper motor is mounted on said adjusting frame, and said adjusting frame is operable to raise or lower said stepper motor and said support base.

7. A scanning-based modeling method, implemented by the three-dimensional scanning device as claimed in claim 1, comprising:
a scanning step where the plurality of optical rangefinders perform scanning on an object to collect multiple point datasets of the object respectively at multiple angles relative to the object, and the distance measuring module transmits the multiple point datasets to a processing system; and
a converting step where the processing system converts the multiple point datasets into three-dimensional coordinates, and constructs a complete model of the object based on the three-dimensional coordinates.

8. The scanning-based modeling method as claimed in claim 7, further comprising a preparing step before the scanning step, wherein in the preparing step, the object is placed on the support base, and in the scanning step, the stepper motor drives the support base to rotate at least one full revolution, during which the plurality of optical rangefinders scan the object.

9. The scanning-based modeling method as claimed in claim 7, further comprising a preparing step before the scanning step, wherein in the preparing step, the bracket is detached from the shell, and in the scanning step, the bracket, along with the plurality of optical rangefinders, is moved by one of a machine and a person around the object for at least one full revolution, during which the plurality of optical rangefinders scan the object.

10. A scanning-based modeling method, implemented by a plurality of three-dimensional scanning devices, each of which is as claimed in claim 1, the scanning-based modeling method comprising:
a preparing step where the plurality of three-dimensional scanning devices are arranged around an object at different angles relative to the object, and the plurality of three-dimensional scanning devices are spaced apart from each other;
a scanning step where the plurality of optical rangefinders of the plurality of three-dimensional scanning devices perform scanning on the object to collect multiple point datasets of the object respectively from the plurality of three-dimensional scanning devices, and the distance measuring modules of the plurality of three-dimensional scanning devices transmit the multiple point datasets to a processing system; and
a converting step where the processing system converts each of the multiple point datasets into three-dimensional coordinates, constructs a local model of the object based on the three-dimensional coordinates for each of the multiple point datasets, and combines the local models respectively constructed for the multiple point datasets to form a complete model of the object.
